(19) United States
(12) Patent Application Publication
(10) Pub. No.: US 2021/0399643 A1
(43) Pub. Date: Dec. 23, 2021

(54) Active Clamp Resonant Flyback Converter with Integrated Boost Stage

(71) Applicant: Apple Inc., Cupertino, CA (US)

(72) Inventor: InHwan Oh, Cupertino, CA (US)

(21) Appl. No.: 17/327,301

(22) Filed: May 21, 2021

Related U.S. Application Data
(60) Provisional application No. 63/040,202, filed on Jun. 17, 2020.

(51) Int. Cl. H02M 3/335; H02M 1/08

(52) U.S. Cl. CPC H02M 3/33571; H02M 1/083

(57) ABSTRACT

A single-stage power converter can include a boost segment configured to receive an input DC voltage and a flyback segment configured to generate an output DC voltage. The boost and flyback segments may share common switching devices, including a main switch and an auxiliary switch. The boost segment can further include a boost inductor. The flyback segment can further include a bulk capacitor, a resonant capacitor, a flyback transformer, and an output rectifier. The flyback segment can still further include a resonant inductance in addition to a primary winding of the flyback transformer, which may be a parasitic inductance and/or a discrete inductor. The converter can further include control circuitry configured to vary timing, frequency, and/or duty cycle of the main switch to regulate the output voltage. The converter can still further include a rectifier configured to receive an AC input voltage and produce the DC input voltage.

### BACKGROUND

AC/DC power converters are employed in a variety of applications to provide power from the AC utility mains to personal electronic devices that operate using DC power systems. Such converters may be designed to accommodate a variety of conflicting requirements relating to: power rating, efficiency, size (power density), cost, etc. It is common for many existing designs to employ a DC bulk capacitor to continue supplying power (voltage) to the converter/load during the zero-crossing periods of the AC input waveform. However, in many applications the capacitance and voltage rating of this DC bulk capacitor required to meet the electrical operating requirements can result in a physical size that is undesirable.

Additionally, in some applications employ two-stage converter designs in which an input boost converter and/or power factor correction stage is provided ahead of a main power conversion stage. Such arrangements may be provided to meet various design requirements such as range of acceptable input voltages or power factor correction requirements for loads beyond a certain level. This additional switching stage may introduce additional components that increase cost, space requirements, and complexity while potentially decreasing reliability.

### SUMMARY

Thus, it would be desirable to provide an improved power converter design that could be used to meet various types of power converter design requirements while reducing component count, complexity, and physical size, while maintaining or improving operating efficiency.

An active clamp resonant flyback converter with an integrated boost stage can include a boost inductor having a first terminal couplable to a DC input voltage, a main switch coupled between a second terminal of the boost inductor and ground, an auxiliary switch coupled between the second terminal of the boost inductor and a first terminal of a resonant capacitor, a bulk capacitor coupled to a second terminal of the resonant capacitor, at least one inductance coupled between the second terminal of the resonant capacitor and the second terminal of the boost inductor, a second inductance magnetically coupled to the first inductance, and a rectifier coupled to the second inductance and configured to deliver an output current to a load, wherein the main switch and the auxiliary switch are configured to be alternately operated to deliver a regulated output voltage to the load. The at least one inductance can include a primary winding of a flyback transformer, and the second inductance can include a secondary winding of a flyback transformer. The at least one inductance further can further include a resonant inductance, which may be a parasitic inductance and/or a discrete inductor. The converter can further include a rectifier configured to receive an AC input voltage and produce the DC input voltage. The converter can further include a control circuit configured to vary at least one of a timing, frequency, or duty cycle of the main switch to regulate the output voltage.

A single-stage power converter can include a boost segment configured to receive an input DC voltage and a flyback segment configured to generate an output DC voltage, wherein the boost segment and the flyback segment share common switching devices. The common switching devices can include a main switch and an auxiliary switch. The boost segment can further include a boost inductor. The flyback segment can further include a bulk capacitor, a resonant capacitor, a flyback transformer, and an output rectifier. The flyback segment can still further include a resonant inductance in addition to a primary winding of the flyback transformer. The resonant inductance may be a parasitic inductance or a discrete inductor. The converter can further include a control circuit configured to vary at least one of a timing, frequency, or duty cycle of the main switch to regulate the output voltage. The converter can still further include a rectifier configured to receive an AC input voltage and produce the DC input voltage.

A method of operating a single-stage power converter having a boost segment configured to receive an input DC voltage and a flyback segment configured to generate an output DC voltage, wherein the boost segment and the flyback segment share common switching devices including a main switch and an auxiliary switch and an auxiliary switch, can include turning on the main switch, thereby establishing a first current through a boost inductor of the boost segment, thereby storing energy in the boost inductor, and establishing a second current through a primary winding of the flyback segment, thereby transferring energy stored in a bulk capacitor to a flyback transformer. The method may also include, at a first time determined by a controller of the converter, turning off the main switch, wherein turning off the main switch causes energy stored in the boost inductor to be delivered to the bulk capacitor and allows energy stored in the flyback transformer to be delivered to a load. The method may also include, at a second time determined by the controller, turning on the auxiliary switch, wherein turning on the auxiliary switch allows a reverse current through the primary winding to reverse due to resonant operation of the flyback segment. The method may also include, at a third time determined by the controller, turning off the auxiliary switch, thereby enabling delivery of energy to the bulk capacitor and zero voltage switching turn on of the main switch. The controller may be configured to determine the first time to regulate the output DC voltage. The controller may be configured to determine the second time as a fixed delay following the first time, and the fixed delay may be selected to allow zero voltage switching turn on of the auxiliary switch. The controller may be configured to determine the third time responsive to an output current of the converter reaching zero, and the third time may occur following a fixed delay after the output current of the converter reaching zero.

### BRIEF DESCRIPTION OF THE DRAWINGS

FIG. 1 illustrates a two stage converter with a boost stage and an active clamp resonant flyback converter stage.

FIG. 2 illustrates an active clamp resonant flyback converter with an integrated boost stage.

FIGS. 3A-3F illustrate operating modes corresponding to switching stages of an active clamp resonant flyback converter with an integrated boost stage.

FIG. 4 illustrates various waveforms and operating modes corresponding to switching stages of an active clamp resonant flyback converter with an integrated boost stage.

FIG. 5 illustrates a simplified control circuit arrangement for an active clamp resonant flyback converter with an integrated boost stage.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth in order to provide a thorough understanding of the implementations described herein. In other instances, methods, procedures and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

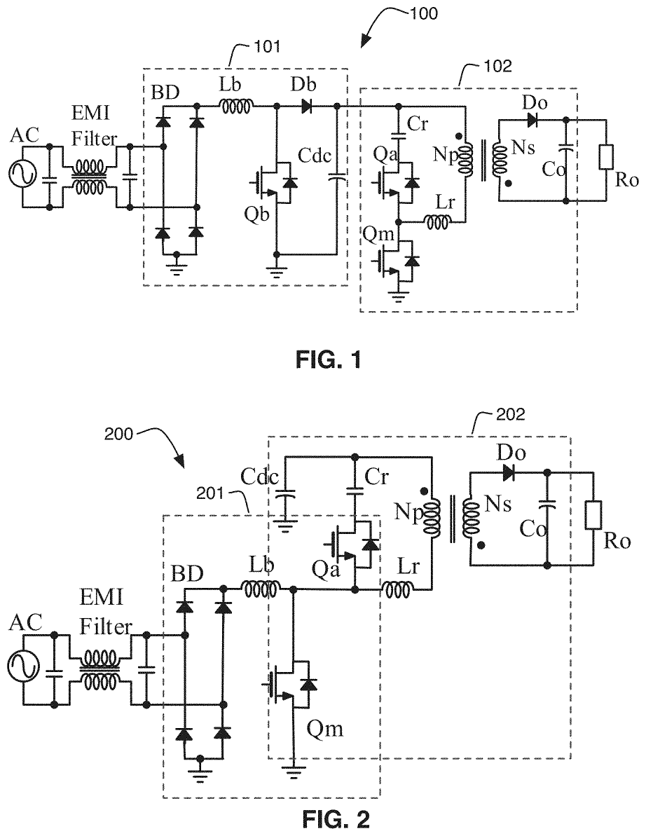

FIG. 1 illustrates an AC/DC power converter 100. Converter 100 receives an AC input voltage, which passes through an EMI filter, to a first boost/power factor correction (PFC) stage 101. The output of the boost/PFC stage 101 is provided to a resonant flyback converter 102, which produces an output voltage suitable for the load, depicted as resistor Ro.

Various circuit configurations for boost/PFC stage 101 are possible. In the illustrated embodiment, boost/PFC stage 101 includes a full bridge rectifier BD, which rectifies the incoming AC voltage into a full-wave rectified DC waveform. This full-wave rectified DC waveform is coupled to a boost/PFC converter that includes boost inductor Lb, boost switch Qb, and boost diode Db. Operation of boost/PFC converters is known to those skilled in the art and thus will not be repeated here. The output voltage of the boost/PFC converter is applied to a DC bulk capacitor Cdc, which stores energy so that flyback converter stage 102 will still have a suitable input voltage even in the vicinity of zero-crossings of the input AC voltage waveform.

Flyback converter stage 102 converts the DC voltage appearing across DC bulk capacitor Cdc into a DC voltage suitable for load Ro. As with the boost/PFC converter, various circuit configurations are also possible for flyback converter 102. In the illustrated embodiment, flyback converter stage 102 is an active clamp resonant flyback converter. The active clamp flyback converter includes a main switch Qm that alternately applies the DC bulk capacitor voltage to the primary winding Np of a flyback transformer (which may also be considered as a first coupled inductor). During the on-time of main switch Qm, energy is stored in the magnetic field of the flyback transformer/coupled inductors. When main switch Qm is opened, the voltages appearing across primary winding/inductor Lp and secondary winding/coupled inductor Ls reverse, delivering energy through output rectifier diode Do to load Ro. When main switch Qm is opened, auxiliary switch Qa may be closed, primary current to circulate through clamp/resonant capacitor Cr. Resonant operation of capacitor Cr and inductance Lr (which may be a discrete inductor and/or may be the leakage inductance of the flyback transformer allows energy that would otherwise be lost (e.g., due to switching losses of main switch Qm or otherwise dissipated in the circuit) to be recovered and returned to the system.

Operation of active clamp flyback converters is known to those skilled in the art, and thus further details of their operation will not be repeated here. As noted above, the incorporation of a boost/PFC stage 101 and a flyback converter stage 102 into a single converter result in two-stage conversion that may decrease operating efficiency of the overall converter 100 in at least some operating regimes.

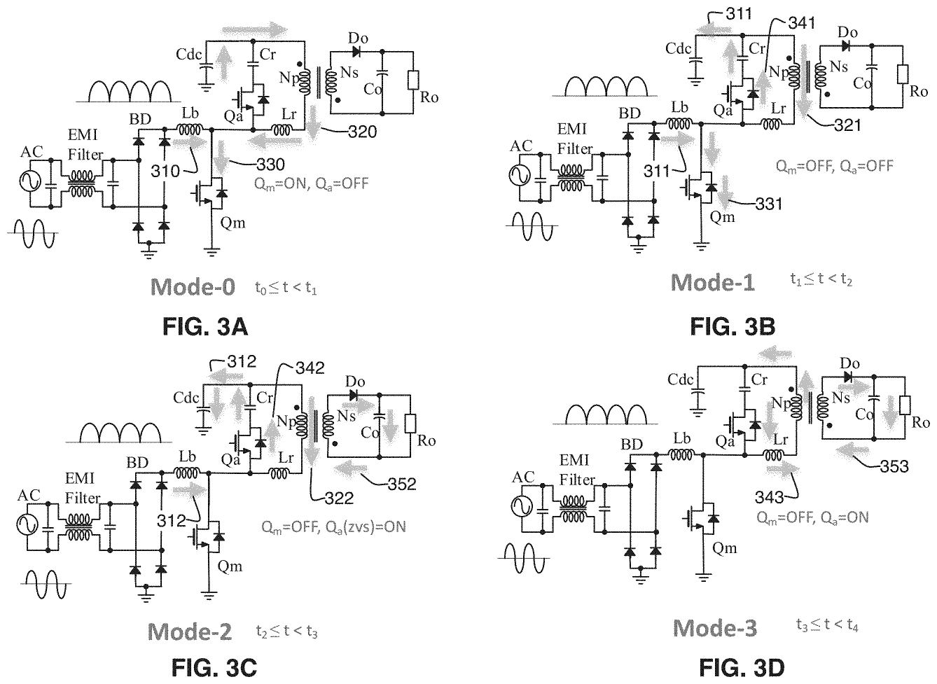

FIG. 2 illustrates an active clamp resonant flyback converter 200 that includes an integrated boost segment 200. As explained in greater detail below, the illustrated converter may be operated as an integrated unit while still providing the same benefits of the two-stage design depicted in FIG. 1. Converter 200 includes a boost segment 201 that includes the input rectifier bridge BD, boost inductor Lb, main switch Qm (which acts as both boost switch and flyback switch as described in greater detail below) and boost rectifier Qa (which acts as boost diode and flyback auxiliary switch as described in greater detail below). Converter 200 also includes active clamp resonant flyback converter segment 202 that includes main switch Qm and auxiliary switch Qa (which are shared with boost stage 201). Flyback segment 202 also includes a flyback transformer including primary winding Np and secondary winding Ns, which may also be considered as coupled inductors. Flyback segment 202 still further includes secondary side rectifier Do and output filter capacitor Co, which deliver energy to the load Ro as described in greater detail below. Turning back to the primary side of flyback segment 202, resonant capacitor Cr and resonant inductance Lr are provided. As discussed above with respect to FIG. 1, resonant inductance Lr may be a separate discrete inductor or may be the leakage inductance of primary winding/inductor Lp. Finally, in converter 200, bulk capacitor Cdc has become part of the flyback segment, as explained in greater detail below.

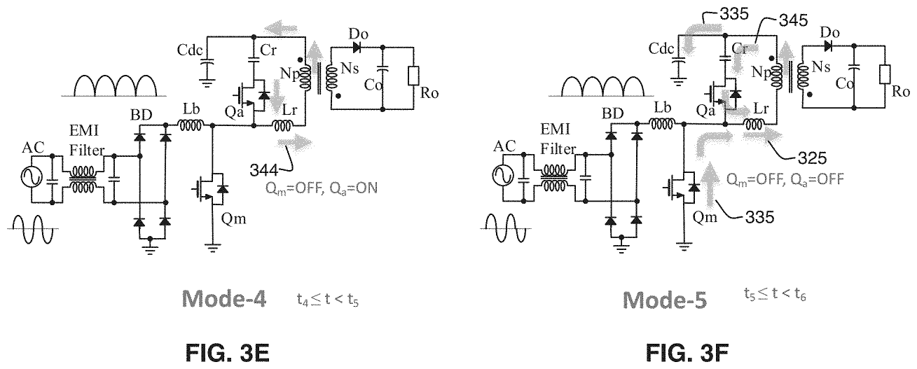

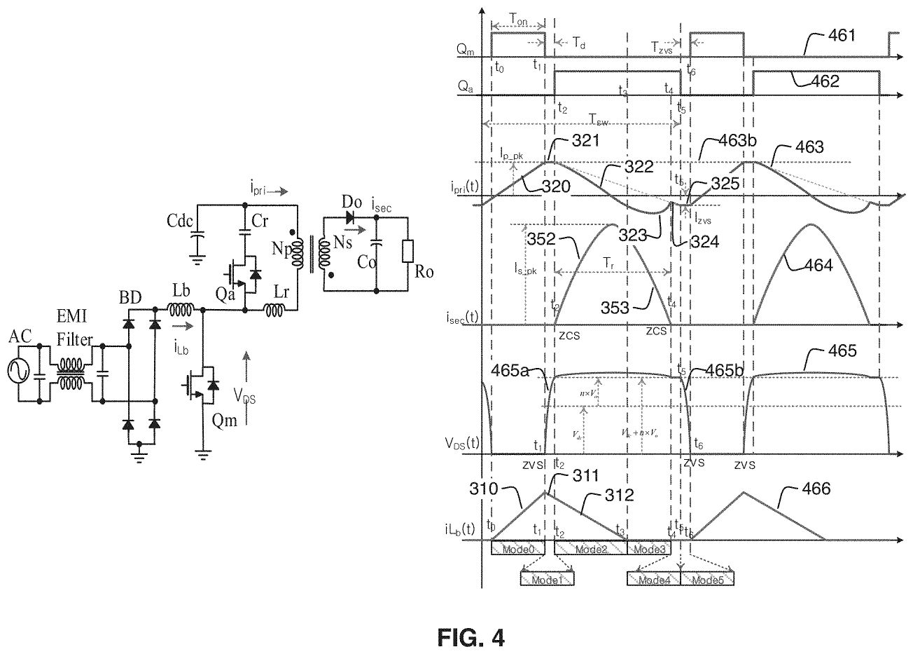

FIGS. 3A-3F depict schematics of converter 200 with current flows for six switching modes 0-5 that may be employed to operate the converter. FIG. 3A depicts switching mode 0, which corresponds to a switching state beginning at time t0 and extending until time t1. FIG. 3B depicts switching mode 1, which corresponds to a switching state beginning at time t1 and extending to time t2, and so on. FIG. 4 illustrates various waveforms associated with the respective switching states and is described in greater detail below. Operation of an active clamp resonant flyback converter with an integrated boost stage 200 may include sequentially stepping through switching modes 0-5, with the frequency, timing, and/or duty cycle of the switching transitions being directed by a control circuit (e.g., a PWM controller, not shown) to maintain a desired output voltage or other regulation parameter.

FIG. 3A illustrates a first switching mode, Mode-0 of an active clamp resonant flyback converter with an integrated boost stage. In Mode-0, main switch Qm is turned on, and auxiliary switch Qa is turned off. Turning on main switch Qm causes a first current 310 to flow from the AC input source through boost inductor Lb. Likewise, turning on main switch Qm causes a second current 320 to flow from bulk DC capacitor Cdc, through primary winding Lp and resonant inductance Lr. Thus, the total current 330 flowing through switch Qm is the sum of current 310 and 320. Mode-0 begins at time to, when Qm is turned on (closed) and extends until time t1, when Qm is turned off (opened). The duration of this interval may be controlled by a control circuit (not shown) to maintain a desired regulated output voltage across load Ro and/or to maintain a desired voltage across DC bulk capacitor Cdc.

At time t1, main switch Qm may be turned off, initiating Mode-1, which is illustrated in FIG. 3B. Mode-1 extends from time t1 (when main switch Qm is turned off) until time t2 (when auxiliary switch Qa is turned on, as described in greater detail below). Mode-1 thus corresponds to a brief transition interval or “dead time” between the turn off of main switch Qm and turn on of auxiliary switch Qa, which otherwise have substantially complementary and alternating duty cycles. In other words, except for the short transition intervals/dead times, main switch Qm is on when auxiliary switch Qa is off and vice versa. Main switch Qm does not turn off instantaneously, so for a brief period there will be a continued, decreasing current flow 331 through main switch Qm. The decrease of current 331 through main switch Qm is discussed in greater detail below with respect to FIG. 4. Also during Mode-1, current 311 flowing through boost inductor Lb cannot change instantaneously, so it continues to flow in the same direction, with some portion passing through main switch Qm as a component of current 331, and some portion passing through the intrinsic body diode of auxiliary switch Qa as a component of current 341. Current 311 then circulates to bulk DC capacitor Cdc. Similarly, current 321 passing through primary winding Np and resonant inductance Lr cannot change instantaneously when main switch Qm is opened, so it, too, continues to flow, circulating through auxiliary switch Qa and resonant capacitor Cr as a component of current 341. Current 341 passing through the intrinsic body diode of auxiliary switch Qa allows auxiliary switch Qa to be turned on at time t2 in a zero voltage switching (ZVS) transition. This marks the transition from Mode-1 to Mode-2.

Mode-2, illustrated in FIG. 3C, begins at time t2 and extends until time t3 when the energy stored in boost inductor Lb is depleted, i.e., transferred to bulk capacitor Cdc. Depletion of the energy in boost inductor Lb at time t3 results in zero current through the inductor, which marks the transition to Mode-3 discussed below. In Mode-2, main switch Qm remains off, while auxiliary switch Qa has been turned on, as described above. During Mode-2, current through main switch Qm is zero, but current 312 through boost inductor Lb continues passing through now turned-on auxiliary switch Qa (as a component of current 342) to bulk capacitor Cdc. At the same time, current 322 through primary winding Np and resonant inductance Lr also continues circulating, also passing through auxiliary switch Qa and resonant capacitor Cr as a component of current 342. Finally, reversal of the voltage across primary winding Np associated with the opening of main switch Qm results in a corresponding reversal of polarity across secondary winding Ns, allowing load current 352 to circulate through now forward biased output diode Do, delivering energy to load Ro. As a result of the foregoing operations, the energy stored in boost inductor Lb during Mode-0 is transferred to bulk capacitor Cdc, a portion of the energy stored in primary winding Np, resonant inductance Lr, and resonant capacitor Cr is delivered to the load.

At time t3, when the energy stored in boost inductor Lb has been transferred to bulk capacitor Cdc, the current through boost inductor Lb and the current into bulk capacitor Cdc becomes zero, marking the transition to Mode-3, illustrated in FIG. 3D. In Mode-3, auxiliary switch Qa remains turned on, and main switch Qm remains turned off. As can be seen more clearly with respect to FIG. 4, discussed below, at the same time t3, resonating current 343, i.e., the current circulating through primary winding Np, resonant inductance Lr, auxiliary switch Qa, and resonant capacitor Cr reverses. Resonating/circulating current 343 is the only current flowing on the primary side during Mode-3. Simultaneously, load current 353 continues to deliver a portion of the energy stored in the flyback transformer (corresponding to the amount of energy stored in the resonant circuit made up of resonant inductance Lr, primary winding Lp, and resonant capacitor Cr) to load Ro.

At time t4, load current 353 reaches zero, marking the transition to Mode-4 illustrated in FIG. 3E. Load current 353 reaching zero also coincides with and corresponds to a reverse biasing of output diode Do. In Mode-4, auxiliary switch Qa remains turned on, while main switch Qm remains turned off. The only current flow in Mode-4 is the continued circulation of resonant/circulating current 344 through resonant inductance Lr, primary winding Np, resonant capacitor Cr, and auxiliary switch Qa. At time t5, shortly after entering Mode-4, auxiliary switch Qa may be turned off, marking the transition to Mode-5. The delay between time t4 (load current on the secondary side reaching zero) and time t5 (auxiliary switch Qa turning off) may be set by the controller (not shown) as a fixed delay, or may be otherwise controlled as necessary to achieve any desired circuit operation conditions.

With the turn off of auxiliary switch Qa at time t5, Mode-5, illustrated in FIG. 3F begins. In Mode-5, main switch Qm remains off, and auxiliary switch Qa is turning off. It will be appreciated that it takes a finite time for auxiliary switch Qa to transition from on to off, resulting in a decaying current 345 passing through resonant capacitor Cr and auxiliary switch Qa. Despite Qa turning off, the flow of current 325 through resonant inductance Lr and primary winding Np cannot change instantaneously, so current 335 begins to be drawn through the intrinsic body diode of main switch Qm, which returns to ground through bulk capacitor Cdc as current 335. Once Qa has fully transitioned off, and current 335 is established through the body diode of main switch Qm, main switch Qm may be turned on at time t6 as a zero voltage switching (ZVS) transition. Thus, time t6 also corresponds to time t0 discusses above with respect to Mode-0 and FIG. 3A, and the operating cycle repeats.

FIG. 4 illustrates active clamp flyback converter 200 with waveforms and timing diagrams corresponding to the operating modes discussed above with respect to FIG. 3. More specifically, FIG. 4 illustrates the following waveforms:
Main switch gate drive signal 461;
Auxiliary switch gate drive signal 462;
Primary winding current 463 (depicted as ipri in the schematic of FIG. 4);
Secondary winding/load current 464 (depicted as isec in the schematic of FIG. 4);
Main switch drain-to-source voltage 465 (depicted as VDS in the schematic of FIG. 4); and
Boost inductor current 466 (depicted as iLb in the schematic of FIG. 4).
   As discussed above, switching Mode-0 begins at time t0 with the turn on of main switch Qm and ends at time t2 with the turn off of main switch Qm, as illustrated by main switch gate drive waveform 461. Mode-0 thus extends for an interval Ton corresponding to the on time of main switch Qm. Mode-0 includes a linearly increasing primary winding current segment 320, depicted on waveform 463 in FIG. 4 and discussed above with respect to FIG. 3A. Mode-0 also includes a linearly increasing boost inductor current segment 310 depicted on waveform 466 in FIG. 4 and also discussed above with respect to FIG. 3A. Also depicted in FIG. 4 is a peak current threshold 463b, corresponding to a current level at which main switch Qm may be turned off to maintain regulation of the output voltage (as alluded to above).

As discussed above with respect to FIG. 3B, Mode-1 corresponds to the transition time between the turn off of main switch Qm at time t1 and the turn on of auxiliary switch Qa at time t2, as depicted in FIG. 4 with respect to switch gate drive waveforms 461 and 462. During this interval, primary winding current continues to flow but stops increasing and begins to decrease as depicted by current segment 321 on primary current waveform 463. During this same interval, the drain-to-source voltage across main switch Qm increases, as depicted by segment 465a of VDS waveform 465. Finally, as was discussed above, boost inductor current 466 begins decreasing, as depicted by current segment 311.

Mode-2 begins at time t2 with the turn on of auxiliary switch Qa as depicted with respect to auxiliary switch gate drive waveform 462. This turn on takes place after a dead time Td after the turn off of main switch Qm, as depicted on main switch gate drive waveform 461. As discussed above with respect to FIG. 3C, Mode-2 corresponds to a decreasing primary winding current, illustrated by current segment 322 of primary current waveform 463. Likewise, Mode-2 includes the instantiation of a sinusoidal half-cycle secondary/load current 464, depicted by current segment 352, which reaches a peak value Is_pk and extends for a resonant period Tr beginning at time t2 and extending until time t4, as depicted in FIG. 4. It should be noted that the turn on of rectifier Do is a zero current switching (ZCS) event. Finally, Mode-2 includes a continued decrease of boost inductor current iLb until reaching zero at time t3, as depicted by current segment 312 of waveform 466.

When boost inductor current 466 reaches zero at time t3, mode 3 begins. As discussed above, Mode-3 extends until time t4, when the secondary current reaches zero. The turn off of output rectifier Do is thus also a zero current switching (ZCS) event. During Mode-3, main switch Qm remains turned off, and auxiliary switch Qa remains turned on, as depicted by gate drive waveforms 461 and 462. Also during Mode-3, primary current 463 initially continues decreasing (becoming more negative) before reversing, as depicted by current segment 332. This corresponds to the resonant operation described above with respect to FIG. 3D. Also during Mode-3, secondary/output current 464 continues decreasing toward zero, which it reaches at time t4, marking the transition to Mode-4.

As discussed above, Mode-4 extends from time t4, when secondary/load current 464 reaches zero until time t5, when auxiliary switch Qa is turned off, as depicted with reference to gate drive waveform 462. Mode-4 was discussed above with respect to FIG. 3E. During this interval, resonant operation of the primary circuit causes primary current 463 to begin increasing (becoming more negative), as depicted by current segment 324 and described above with respect to the resonant operation. All remain currents in the circuit (i.e., secondary current 464 and boost inductor current 466) remain zero during Mode-4.

As indicated by auxiliary switch gate drive signal 462, auxiliary switch Qa is turned off at time t4, which marks the beginning of Mode-5. Mode-5 was discussed above with respect to FIG. 3F. During Mode-5, primary current 463 continues circulating as indicated by current segment 325. Due to the turn off transition of auxiliary switch Qa, this causes a current flow through the intrinsic body diode of main switch Qm, which brings down the drain-to-source voltage 465 of main switch Qm, as indicated by voltage segment 465b. This allows for main switch Qm to be turned on in a ZVS transition (at time t6, which corresponds to time t0). From this point the cycle repeats.

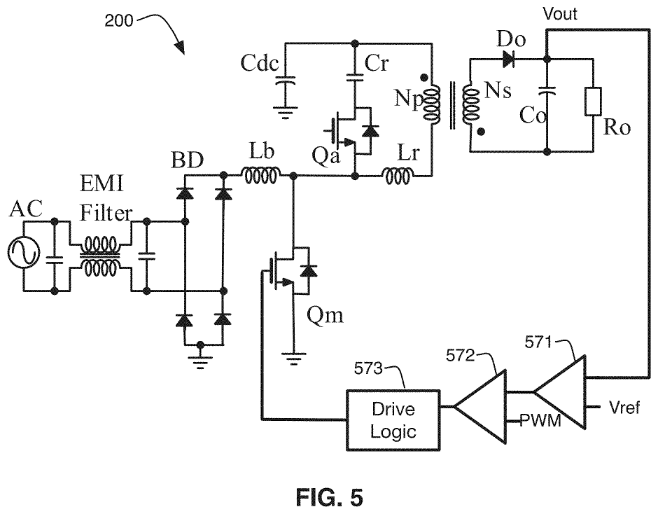

FIG. 5 illustrates a converter 200 implemented as an active clamp resonant flyback converter with integrated boost/PFC stage that includes a simplified block diagram of one exemplary control circuit for the converter. In the illustrated embodiment, converter output voltage Vout is the regulated parameter, but different or additional control loops may be provided to regulate other circuit parameters. For example, additional or alternative control loops may be provided to regulate output current, input voltage and/or current, and/or voltage appearing across bulk capacitor Cdc.

In the illustrated arrangement, output voltage Vout is provided as one input of an error amplifier 571. A reference voltage Vref, corresponding to a desired output voltage is provided to a second input of error amplifier 571. The reference voltage may be generated using any of a multiplicity of known techniques. The difference between the output voltage Vout and the reference voltage Vref is an error signal, the magnitude of which increases the more the output voltage deviates from the setpoint. This error signal may be provided to a PWM comparator 572, which may compare the error signal to a ramp signal PWM. As a result, the output of PWM comparator 572 will be a pulse train, with the width of the pulses being larger for larger error signal inputs and smaller for smaller error signal inputs. This pulse train may be provided to drive logic 573, which may generate the drive signals for main switch Qm with on times corresponding to the widths of the pulses received from PWM comparator 572.

Drive logic 573 may also be coupled to auxiliary switch Qa and may operate auxiliary switch Qa complementarily to main switch Qm, with suitable dead times, as described above. To that end, drive logic 573 may have other inputs (not shown) that receive other circuit parameters and/or the error signals from additional or alternative control loops, such as those identified above. Drive logic 573 may be implemented using discrete circuitry or integrated circuits, or a combination thereof. Additionally, the control loop, including, for example, error amplifier 571 and PWM comparator 572, as well as reference signal generators for the reference voltage and the PWM ramp signal, may be included as part of the drive logic, whether in discrete or integrated circuit form. Additionally, the control circuitry may be implemented as analog, digital, and/or hybrid analog digital circuitry, and could alternatively be implemented with a programmable controller, field programmable gate array, or other suitable circuitry.

The foregoing describes exemplary embodiments of an active clamp resonant flyback converter with integrated boost/PFC stage. Such systems may be used in a variety of applications but may be particularly advantageous when used in conjunction with AC/DC power adapters for consumer electronics devices. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. An active clamp resonant flyback converter with an integrated boost stage, the converter comprising:
a boost inductor having a first terminal couplable to a DC input voltage;
a main switch coupled between a second terminal of the boost inductor and ground;
an auxiliary switch coupled between the second terminal of the boost inductor and a first terminal of a resonant capacitor;
a bulk capacitor coupled to a second terminal of the resonant capacitor;
at least one inductance coupled between the second terminal of the resonant capacitor and the second terminal of the boost inductor;
a second inductance magnetically coupled to the first inductance; and
a rectifier coupled to the second inductance and configured to deliver an output current to a load;
wherein the main switch and the auxiliary switch are configured to be alternately operated to deliver a regulated output voltage to the load.

2. The converter of claim 1 wherein the at least one inductance comprises a primary winding of a flyback transformer, and the second inductance comprises a secondary winding of a flyback transformer.

3. The converter of claim 2 wherein the at least one inductance further comprises a resonant inductance.

4. The converter of claim 3 wherein the resonant inductance is a parasitic inductance.

5. The converter of claim 3 wherein the resonant inductance is a discrete inductor.

6. The converter of claim 1 wherein the at least one inductance further comprises a resonant inductance.

7. The converter of claim 6 wherein the resonant inductance is a parasitic inductance.

8. The converter of claim 6 wherein the resonant inductance is a discrete inductor.

9. The converter of claim 1 further comprising a rectifier configured to receive an AC input voltage and produce the DC input voltage.

10. The converter of claim 1 further comprising a control circuit configured to vary at least one of a timing, frequency, or duty cycle of the main switch to regulate the output voltage.

11. A single-stage power converter comprising:
a boost segment configured to receive an input DC voltage; and
a flyback segment configured to generate an output DC voltage;
wherein the boost segment and the flyback segment share common switching devices.

12. The single-stage power converter of claim 11 wherein the common switching devices include a main switch and an auxiliary switch.

13. The single-stage power converter of claim 12 wherein the boost segment further comprises a boost inductor.

14. The single-stage power converter of claim 12 wherein the flyback segment further comprises a bulk capacitor, a resonant capacitor, a flyback transformer, and an output rectifier.

15. The single-stage power converter of claim 12 wherein the flyback segment further comprises a resonant inductance in addition to a primary winding of the flyback transformer.

16. The single-stage power converter of claim 15 wherein the resonant inductance is a parasitic inductance.

17. The single-stage power converter of claim 15 wherein the resonant inductance is a discrete inductor.

18. The single-stage power converter of claim 12 further comprising a control circuit configured to vary at least one of a timing, frequency, or duty cycle of the main switch to regulate the output voltage.

19. The single-stage power converter of claim 12 further comprising a rectifier configured to receive an AC input voltage and produce the DC input voltage.

20. A method of operating a single-stage power converter having a boost segment configured to receive an input DC voltage and a flyback segment configured to generate an output DC voltage, wherein the boost segment and the flyback segment share common switching devices including a main switch and an auxiliary switch and an auxiliary switch, the method comprising:
turning on the main switch, thereby establishing a first current through a boost inductor of the boost segment, thereby storing energy in the boost inductor, and establishing a second current through a primary winding of the flyback segment, thereby transferring energy stored in a bulk capacitor to a flyback transformer;
at a first time determined by a controller of the converter, turning off the main switch, wherein turning off the main switch causes energy stored in the boost inductor to be delivered to the bulk capacitor and allows energy stored in the flyback transformer to be delivered to a load;
at a second time determined by the controller, turning on the auxiliary switch, wherein turning on the auxiliary switch allows a reverse current through the primary winding to reverse due to resonant operation of the flyback segment;
at a third time determined by the controller, turning off the auxiliary switch, thereby enabling delivery of energy to the bulk capacitor and zero voltage switching turn on of the main switch.

21. The method of claim 20 wherein the controller is configured to determine the first time to regulate the output DC voltage.

22. The method of claim 21 wherein the controller is configured to determine the second time as a fixed delay following the first time, wherein the fixed delay is selected to allow zero voltage switching turn on of the auxiliary switch.

23. The method of claim 22 wherein the controller is configured to determine the third time responsive to an output current of the converter reaching zero.

24. The method of claim 23 wherein the third time occurs following a fixed delay after the output current of the converter reaching zero.
